(19) United States
(12) Patent Application Publication
(10) Pub. No.: US 2011/0113925 A1
(43) Pub. Date: May 19, 2011

(54) METHOD OF AND SYSTEM FOR PROCESSING RED MUD

(76) Inventor: Kevin Philippe Daniel Perry, Lisbon (PT)

(21) Appl. No.: 12/740,739

(22) PCT Filed: Nov. 3, 2008
(86) PCT No.: PCT/GB08/03712

§ 371 Date: Jan. 17, 2011

(30) Foreign Application Priority Data
Nov. 1, 2007 (GB) 0721485.1

(51) Int. Cl. B22F 9/00; C21B 7/14; B22D 11/00; C22B 3/00; B29B 9/00

(52) U.S. Cl. 75/363; 75/582; 164/477; 266/161; 425/7

(57) ABSTRACT

A method of and system for processing red mud, the method comprising the step of heating red mud to form at least molten slag, and preferably at least molten iron and molten slag.

### FIELD OF THE INVENTION

The present invention relates to a method of and system for processing red mud into at least molten slag, and preferably at least molten iron and molten slag.

### BACKGROUND OF THE INVENTION

Red mud is a waste product generated by the aluminium manufacturing industry. In particular, red mud is encountered wherever the alumina ore, called bauxite, first undergoes a pressure leach using soda ash to upgrade its alumina component to over 99%. The solid residue emanating from this hydrometallurgical leaching process is known as red mud, and typically has the following general composition: Fe₂O₃-30 to 60%, Al₂O₃-10 to 20%, SiO₂-3 to 50%, Na₂O-2 to 10%, CaO-2 to 8% and TiO₂-0 to 10%.

In Greece, for example, some 160,000 tons of red mud are generated per annum, the disposal of which has become problematic. Up to now, and of great concern to environmentalists, red mud has been disposed of into the Mediterranean sea at a cost of about US$85 per ton.

### AIM OF THE INVENTION

It is an aim of the present invention to provide a method of and system for processing red mud, ideally in an efficient and environmentally-friendly manner.

### SUMMARY OF THE INVENTION

In one aspect the present invention provides a method of processing red mud, the method comprising the step of heating red mud to form at least molten slag, and preferably at least molten iron and molten slag.

In one embodiment the red mud is heated in a melt furnace to form at least molten slag, and preferably at least molten iron and molten slag.

In one embodiment the method further comprises the steps of separating, preferably pouring off, the molten slag, and converting the molten slag into a granulated product.

In one embodiment the molten slag is separated into a holding furnace.

In one embodiment the step of converting the molten slag into a granulated product comprises the step of contacting the molten slag with a mist jet.

In one embodiment the mist jet is substantially horizontally directed.

In one embodiment the mist jet is a high-speed mist jet, preferably having a speed greater than 100 m/s.

In one embodiment the granulated product comprises glass fibres.

In one embodiment at least molten iron and molten slag are formed, and the method further comprises the step of casting the molten iron into solid product, such as blocks or billets.

In another embodiment at least molten iron and molten slag are formed, and the method further comprises the step of converting the molten iron into ferrosilicon, preferably containing from about 16% to about 18% Si.

In one embodiment the method further comprises the step of casting the ferrosilicon into solid product, such as blocks or billets.

In another embodiment the method further comprises the step of converting the ferrosilicon directly into powder.

In a further embodiment at least molten iron and molten slag are formed, and the method further comprises the step of converting the molten iron directly into powder.

In one embodiment the method further comprises, prior to the step of heating the red mud, the step of drying the red mud, such that the step of heating the red mud comprises the step of heating dried red mud.

In one embodiment the step of drying the red mud comprises the steps of providing a rotating drying tube into one, infeed end of which the red mud is fed and from the other, discharge end of which dried red mud is discharged, and heating the drying tube.

In one embodiment the dried red mud is fed into the melt furnace, preferably by a feed assembly.

In one embodiment the drying tube is heated externally.

In one embodiment the drying tube is heated externally with hot gas from the melt furnace.

In on embodiment the hot gas, following use in heating the drying tube, is filtered to collect red mud dust.

In one embodiment the collected red mud dust is recycled into the melt furnace.

In one embodiment the method further comprises the step of adding silica sand and coke breeze fines to the red mud.

In one embodiment the silica sand and the coke breeze fines are added prior to the step of drying the red mud.

In another aspect the present invention provides an air-water granulation apparatus for producing a granulated product from a molten supply, the apparatus comprising a mist jet generator for generating a mist jet, which produces a granulated product by the action of shearing a molten supply as delivered, preferably poured, into the mist jet.

In one embodiment the mist jet generator comprises a nozzle unit which comprises an air chamber which includes an air inlet and an air outlet from which a jet of compressed air is delivered, and a water chamber which is located adjacent the air outlet and from which water is drawn into the compressed air flow, as a mist, such that the delivered compressed air flow contains a water mist, thereby producing a mist jet.

In one embodiment the air chamber is of generally triangular form in cross section.

In one embodiment the compressed air flow has a speed of at least 100 m/s.

In one embodiment the water chamber includes a water inlet and a water outlet which is located adjacent the air outlet and from which water is drawn into the compressed air flow.

In one embodiment the air outlet is an elongate aperture.

In one embodiment the water outlet is an elongate aperture.

In one embodiment the apparatus further comprises a collection chamber for collecting the granulated product.

In one embodiment the collection chamber includes an exhaust port from which spent air is exhausted.

In one embodiment the granulated product is glass fibre.

In another embodiment the granulated product is a powder.

In a further aspect the present invention provides a system for processing red mud, the system comprising a melt furnace for receiving and heating red mud to form at least molten slag, and preferably at least molten iron and molten slag.

In one embodiment the system further comprises a dryer for drying the red mud prior to heating by the melt furnace.

In one embodiment the system further comprises a feeding assembly for feeding the dried red mud to the melt furnace.

In one embodiment the dryer comprises a rotatable drying tube into one, infeed end of which the red mud is fed and from the other, discharge end of which dried red mud is discharged.

In one embodiment the drying tube is heated externally.

In one embodiment the dryer further comprises an enclosure through which the drying tube extends and which receives hot gas from the melt furnace to heat the drying tube.

In one embodiment the system further comprises a dust extraction unit which receives the hot gas, following use in heating the drying tube, and filters the hot gas to extract red mud dust.

In one embodiment the collected red mud dust is recycled into the melt furnace.

In one embodiment the system further comprises a holding furnace for holding molten slag or molten iron from the melt furnace.

In one embodiment the system further comprises an air-water granulation apparatus for producing a granulated product from a molten supply, comprising a mist jet generator for generating a mist jet, which produces a granulated product by the action of shearing a molten supply as delivered, preferably poured, into the mist jet.

In one embodiment the mist jet generator comprises a nozzle unit which comprises an air chamber which includes an air inlet and an air outlet from which a flow of compressed air is delivered, and a water chamber which is located adjacent the air outlet and from which water is drawn into the compressed air flow, as a mist, such that the delivered compressed air flow contains a water mist, thereby producing a mist jet.

In one embodiment the air chamber is of generally triangular form in cross section.

In one embodiment the compressed air flow has a speed of at least 100 m/s.

In one embodiment the water chamber includes a water inlet and a water outlet which is located adjacent the air outlet and from which water is drawn into the compressed air flow.

In one embodiment the air outlet is an elongate aperture.

In one embodiment the water outlet is an elongate aperture.

In one embodiment the system further comprises a collection chamber for collecting the granulated product.

In one embodiment the collection chamber includes an exhaust port from which spent air is exhausted.

In one embodiment the granulated product is glass fibre.

In another embodiment the granulated product is a powder.

In one embodiment the red mud is mixed with coke breeze fines and silica sand.

### BRIEF DESCRIPTION OF THE DRAWINGS

Preferred embodiments of the present invention will now be described hereinbelow by way of example only with reference to the accompanying drawings, in which:

FIG. 1 schematically illustrates a processing system for processing red mud in accordance with a preferred embodiment of the present invention;

FIG. 2 schematic illustrates an air-water granulation apparatus in accordance with a preferred embodiment of the present invention; and

FIGS. 3(a) to (c) illustrate top, vertical sectional (along section I-I) and front views of the nozzle of the air-water granulation apparatus of FIG. 2.

### DESCRIPTION OF THE PREFERRED EMBODIMENTS

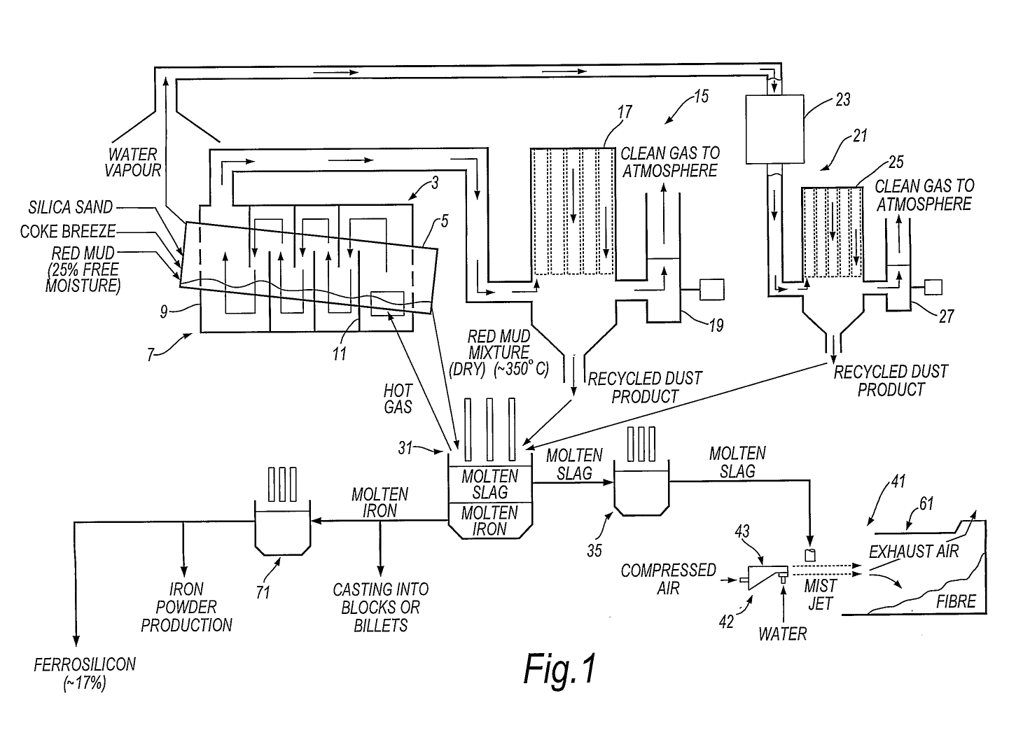

FIG. 1 illustrates a processing system for processing red mud in accordance with a preferred embodiment of the present invention.

In this embodiment the processing system comprises a dryer 3 for drying red mud, which, in being a filter product from a hydrometallurgical operation, contains a high moisture content, typically some 25% by mass.

In this embodiment the dryer 3 comprises a rotating drying tube 5 which is heated, here externally, and into one end of which, the infeed end, red mud is fed, here as a mixture together with silica sand and coke breeze fines.

In this embodiment the drying tube 5 comprises a slowly rotating, refractory-lined cylinder, here alumina lined.

In this embodiment the dryer 3 further comprises a heating unit 7 which contains a heated gas and through which the drying tube 5 extends.

In this embodiment the heating unit 7 comprises an enclosure 9, here in the form of a box, which is fed with hot, heating gas drawn from a melt reduction furnace 31, as will be described in more detail hereinbelow. External heating of the drying tube 5 is preferred as this reduces the generation and hence carry-over of red mud dust.

In this embodiment the heating enclosure 9 includes vertical partitions 11 which force the hot gas to ‘snake’ up and down over the outer surface of the drying tube 5, before exiting and being filtered in an adjoining bag house 17, as will be described in more detail hereinbelow.

There are a number of advantages to using hot furnace gases as the means of heating, which include:
(i) The process effectively decreases the carbon ‘footprint’ (i.e. tons CO₂ generated per ton red mud), as decreasing the moisture in the melt reduction furnace 31 means that less coke breeze will be required and so, in turn, generating less carbon dioxide.
(ii) No electrical power will be wasted in converting moisture (both free and crystalline) into hydrogen, thereby resulting in an in increase in furnace throughput.
(iii) Increased furnace throughput for the same electrical power input, which reduces the carbon ‘footprint’ of the process.

In this embodiment the system further comprises a gas treatment unit 15 for treating the heating gas following use in the heating unit 7.

In this embodiment the gas treatment unit 15 comprises a dust extractor 17, here in the form of a bag house, which extracts dust from the heating gas, and an extraction fan 19 for drawing heating gas from the heating unit 7 through the dust extractor 17. In this embodiment the extracted dust is recycled, here fed into the melt reduction furnace 31.

In this embodiment the system further comprises a condenser unit 21 for condensing water vapour or steam generated within the dryer 3.

The condenser unit 21 comprises a condenser 23 for condensing water vapour extracted from the dryer 3, a filter unit 25, in this embodiment a small bag filter unit, downstream of the condenser 23, and an extraction fan 27, preferably low kVA, for drawing gas, containing water vapour, from the dryer 3 through the condenser 23 and the filter unit 25 and expelling the same to atmosphere as a clean gas.

In this embodiment silica sand and coke breeze fines are added to the red mud, and, in order to facilitate mixing in of the silica sand and coke breeze fines into the red mud, these two components are preferably added together with the wet red mud at the infeed end of the drying tube 5. The coke breeze will not burn because the maximum temperature reached within the drying tube 5 is typically between 350° C. and 450° C.

The processing system further comprises a melt reduction furnace 31, typically a 5 MVA furnace, which receives the heated red mud mixture from the discharge end of the drying tube 5.

Transferring the heated red mud mixture from the drying tube 5 to the melt reduction furnace 31 can be done in several ways. In one embodiment the heated red mud mixture is transferred by a feed unit, here refractory lined, into which the red mud mixture falls under gravity from the discharge end of the drying tube 5 and which is operative to regulate feeding of the red mud mixture into the melt reduction furnace 31.

In one embodiment the feed unit comprises a hopper, having sharply inclined sides towards its lower end, which receives the heated red mud mixture from the drying tube 5, a chamber for collecting the red mud mixture, and a feeder, preferably a spiral feeder, for transferring the red mud mixture via an inclined tubular shaft into the melt reduction furnace 31, here via a charging chute of the melt reduction furnace 31. In one embodiment the spiral feeder can be powered by a variable-speed drive motor whose speed is controlled or set by the furnace operator so that the rate at which the red mud mixture is charged into the melt reduction furnace 31 is directly proportional to the angular speed of the drive motor.

Once charged to the melt reduction furnace 31, a hot molten bath will be formed, typically at a temperature of around 1610° C. Three products will be produced in the furnace bowl of the melt reduction furnace 31 simultaneously and on a continuous basis, these being molten iron which accumulates at the bottom of the furnace bowl, a molten glassy slag which overlies the molten iron and a hot gas enriched in carbon dioxide.

In this embodiment the processing system further comprises a further melt reduction furnace 35, preferably 2 MVA, as a secondary furnace, into which the molten glassy slag is transferred. The furnace bowl of the secondary melt reduction furnace 35 is of a size to accommodate the volume of molten slag produced in every heat of the primary melt reduction furnace 31.

In this embodiment the molten slag is used for the production of granulated glass product, here glass fibre, and the secondary melt reduction furnace 35 is configured for optimal production of glass fibre.

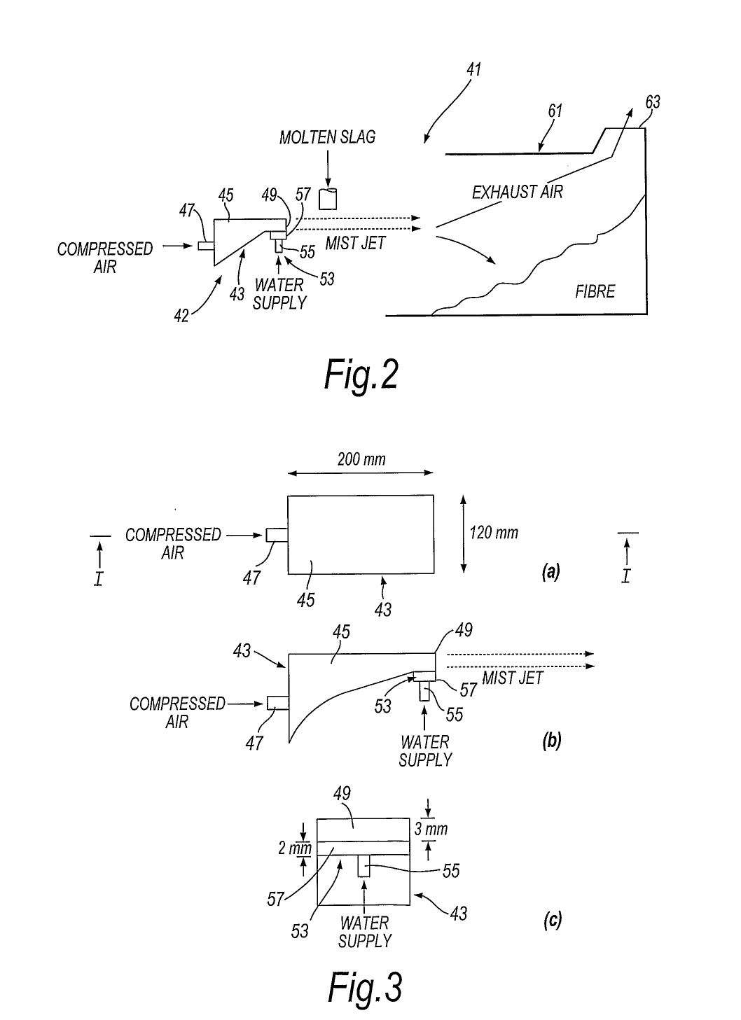

The processing system further comprises an air-water granulation apparatus 41 for producing a granulated glass product, here glass fibre, as particularly illustrated in FIGS. 2 and 3.

In this embodiment the granulation apparatus 41 comprises a high-speed mist jet generator 42 for generating a high-speed mist jet, which produces a granulated glass product by the action of shearing the molten slag as delivered, here poured, thereto.

In this embodiment the mist jet generator 42 comprises a nozzle unit 43 which includes an air chamber 45, here of generally triangular form in cross section, which includes an air inlet 47 at one, the rear, end thereof and an air outlet 49 at the other, forward, end thereof from which a jet or flow of compressed air is delivered, here at a speed of at least 100 m/s, and a water chamber 53 which is located adjacent the air outlet 49 and from which water is drawn into the compressed air flow, here as a mist, typically in the form of minute droplets, such that the delivered compressed air flow contains a water mist, here as a lesser fraction, thereby producing a high-speed mist jet.

In this embodiment the water chamber 53 includes a water inlet 55 and a water outlet 57 which is located adjacent the air outlet 49 and from which water is drawn into the compressed air flow.

In this embodiment the air chamber 45 has a length between the air inlet 47 and the air outlet 49 of about 200 mm, and the air outlet 49 is an elongate aperture, here having a length of about 120 mm and a height of about 3 mm.

In this embodiment the water outlet 57 is an elongate aperture, here having a length of about 120 mm and a height of about 2 mm.

In this embodiment the nozzle 43 is made from sheet pieces, here approximately 3 mm thick sheet steel pieces, which are welded together to form a box-type container.

In this embodiment the molten slag is delivered, here poured, into the high-speed mist jet, which acts to shear the molten slag and instantly produce a granulated glass product, here in elongated pieces, here as glass fibres.

The granulation apparatus 41 further comprises a collection chamber 61 into which the glass fibres fall under gravity.

In this embodiment the collection chamber 61 includes an exhaust port 63 at the upper, rear edge thereof, from which spent air is exhausted. In this embodiment the exhaust port 63 includes a filter, typically a filter grid having a 10 mm aperture size, to prevent glass fibre from escaping with the exhaust gas.

In this embodiment the collection chamber 61 is a simple sheet steel or aluminium-lined chamber.

Returning to the primary melt reduction furnace 31, there are different options for handling the molten iron following the pouring off of the molten slag.

In one embodiment the molten iron can be cast into blocks or billets, which can then be sold into the steel industry.

In another embodiment the processing system could include a further melt reduction furnace 71, preferably 2 MVA, which is utilized to convert the molten iron into ferrosilicon, preferably containing about 16% to about 18% Si. In one embodiment the above-described air-water granulation apparatus 41 or another air-water granulation apparatus could be used to convert the molten ferrosilicon directly into a fine particulate mass which will be highly spheroidal in morphology and would have many applications, including use in the field of heavy media separation.

In a further embodiment the above-described granulation apparatus 41 or another air-water granulation apparatus could be used to convert the molten iron directly into a powder. Iron powder has a number of applications, including use in the filed of metal injection moulding (MIM), where items are made by pressing the metal powder, together with a binder, into a desired shape, which is then sintered in a box furnace, typically at about 1000° C., to produce an item which has far superior mechanical properties than the same item when cast or cut out from a block. In one embodiment a further melt reduction furnace 71 is utilized to pour the molten iron, although, if furnace availability permits, generating metal powder by pouring directly from the primary melt reduction furnace 31 would be possible.

The present invention thus discloses a convenient and simple way of processing red mud so as to also yield saleable products.

Finally, it will be understood that the present invention has been described in its preferred embodiments and can be modified in many different ways without departing from the scope of the invention as defined by the appended claims.

1. A method of processing red mud, the method comprising the step of heating red mud, optionally in a melt furnace, to form at least molten slag, preferably at least molten iron and molten slag.

2. (canceled)

3. The method of claim 1, further comprising the steps of separating, optionally pouring off, the molten slag, and converting the molten slag into a granulated product, optionally the molten slag is separated into a holding furnace.

4. (canceled)

5. The method of claim 3, wherein the step of converting the molten slag into a granulated product comprises the step of contacting the molten slag with a mist jet, optionally the mist jet is substantially horizontally directed, optionally the mist jet is a high-speed mist jet, preferably having a speed greater than 100 m/s.

6. (canceled)

7. (canceled)

8. The method of claim 3, wherein the granulated product comprises glass fibres.

9. The method of claim 1, wherein at least molten iron and molten slag are formed, and further comprising the step of (i) casting the molten iron into solid product, such as blocks or billets, (ii) converting the molten iron into ferrosilicon, optionally containing from about 16% to about 18% Si, optionally further comprising the step of casting the ferrosilicon into solid product, such as blocks or billets, or converting the ferrosilicon directly into powder, or (iii) converting the molten iron directly into powder.

10. (canceled)

11. (canceled)

12. (canceled)

13. (canceled)

14. The method of claim 1, further comprising, prior to the step of heating the red mud, the step of drying the red mud, such that the step of heating the red mud comprises the step of heating dried red mud, optionally the step of drying the red mud comprises the steps of providing a rotating drying tube into one, infeed end of which the red mud is fed and from the other, discharge end of which dried red mud is discharged, and heating the drying tube, optionally the dried red mud is fed into the melt furnace, optionally by a feed assembly.

15. (canceled)

16. (canceled)

17. The method of claim 14, wherein the drying tube is heated externally, optionally the drying tube is heated externally with hot gas from the melt furnace, optionally the hot gas, following use in heating the drying tube, is filtered to collect red mud dust, optionally the collected red mud dust is recycled into the melt furnace.

18. (canceled)

19. (canceled)

20. (canceled)

21. The method of claim 1, further comprising the step of adding silica sand and coke breeze fines to the red mud.

22. The method of claim 21, further comprising, prior to the step of heating the red mud, the step of drying the red mud, such that the step of heating the red mud comprises the step of heating dried red mud, and wherein the silica sand and the coke breeze fines are added prior to the step of drying the red mud.

23. An air-water granulation apparatus for producing a granulated product from a molten supply, the apparatus comprising a mist jet generator for generating a mist jet, which produces a granulated product by the action of shearing a molten supply as delivered, optionally poured, into the mist jet.

24. The apparatus of claim 23, wherein the mist jet generator comprises a nozzle unit which comprises an air chamber which includes an air inlet and an air outlet from which a jet of compressed air is delivered, and a water chamber which is located adjacent the air outlet and from which water is drawn into the compressed air flow, as a mist, such that the delivered compressed air flow contains a water mist, thereby producing a mist jet, optionally the air chamber is of generally triangular form in cross section, optionally the compressed air flow has a speed of at least 100 m/s, optionally the water chamber includes a water inlet and a water outlet which is located adjacent the air outlet and from which water is drawn into the compressed air flow, optionally the air outlet is an elongate aperture, optionally the water outlet is an elongate aperture.

25. (canceled)

26. (canceled)

27. (canceled)

28. (canceled)

29. (canceled)

30. The apparatus of claim 23, further comprising a collection chamber for collecting the granulated product, optionally the collection chamber includes an exhaust port from which spent air is exhausted.

31. (canceled)

32. The apparatus of claim 23, wherein the granulated product is glass fibre or a powder.

33. (canceled)

34. A system for processing red mud, the system comprising a melt furnace for receiving and heating red mud to form at least molten slag, and preferably at least molten iron and molten slag.

35. The system of claim 34, further comprising a dryer for drying the red mud prior to heating by the melt furnace, optionally further comprising a feeding assembly for feeding the dried red mud to the melt furnace, optionally the dryer comprises a rotatable drying tube into one, infeed end of which the red mud is fed and from the other, discharge end of which dried red mud is discharged.

36. (canceled)

37. (canceled)

38. The system of claim 35, wherein the drying tube is heated externally, optionally the dryer further comprises an enclosure through which the drying tube extends and which receives hot gas from the melt furnace to heat the drying tube, optionally further comprising a dust extraction unit which receives the hot gas, following use in heating the drying tube, and filters the hot gas to extract red mud dust, optionally the collected red mud dust is recycled into the melt furnace.

39. (canceled)

40. (canceled)

41. (canceled)

42. The system of claim 34, further comprising a holding furnace for holding the molten slag or molten iron from the melt furnace.

43. The system of claim 34, further comprising an air-water granulation apparatus for producing a granulated product from a molten supply, comprising a mist jet generator for generating a mist jet, which produces a granulated product by the action of shearing a molten supply as delivered, preferably poured, into the mist jet.

44. The system of claim 43, wherein the mist jet generator comprises a nozzle unit which comprises an air chamber which includes an air inlet and an air outlet from which a flow of compressed air is delivered, and a water chamber which is located adjacent the air outlet and from which water is drawn into the compressed air flow, as a mist, such that the delivered compressed air flow contains a water mist, thereby producing a mist jet, optionally the air chamber is of generally triangular form in cross section, optionally the compressed air flow has a speed of at least 100 m/s, optionally the water chamber includes a water inlet and a water outlet which is located adjacent the air outlet and from which water is drawn into the compressed air flow, optionally the air outlet is an elongate aperture, optionally the water outlet is an elongate aperture.

45. (canceled)

46. (canceled)

47. (canceled)

48. (canceled)

49. (canceled)

50. The system of claim 43, further comprising a collection chamber for collecting the granulated product, optionally the collection chamber includes an exhaust port from which spent air is exhausted.

51. (canceled)

52. The system of claim 43, wherein the granulated product is glass fibre or a powder.

53. (canceled)

54. The system of claim 34, wherein the red mud is mixed with coke breeze fines and silica sand.
